(19) United States
(12) Patent Application Publication
(10) Pub. No.: US 2017/0060980 A1
(43) Pub. Date: Mar. 2, 2017

(54) DATA ACTIVITY TRACKING

(71) Applicant: INTERNATIONAL BUSINESS MACHINES CORPORATION, ARMONK, NY (US)

(72) Inventors: Theodore T. Harris, JR., Tucson, AZ (US); Gregory E. McBride, Vail, AZ (US); David C. Reed, Tucson, AZ (US); Michael R. Scott, Ocean View, HI (US); Richard A. Welp, Manchester (GB)

(21) Appl. No.: 14/834,303

(22) Filed: Aug. 24, 2015

(51) Int. Cl. G06F 17/30

(52) U.S. Cl. CPC G06F 17/30598; G06F 17/303; G06F 17/30339

(57) ABSTRACT

Provided are a computer program product, system, and for data activity tracking in accordance with the present description, in which metadata is read from a storage unit data structure for a storage unit storing data of a plurality of data sets in a plurality of data units of the storage unit. Based upon read metadata, a data set of the storage unit may be classified as one of active and inactive, and if classified as inactive, data units containing data of the inactive classified first data set may be selected. The data of the inactive classified data set may be migrated from the selected data units of a first storage performance tier to a second storage performance tier having a lower level of storage performance than the first storage performance tier. Other aspects of data activity tracking and migration in accordance with the present description are described.

### BACKGROUND OF THE INVENTION

1. Field of the Invention

The present invention relates to a computer program product, system, and method for tracking the level of activity of data in multiple performance tier levels of storage.

2. Description of the Related Art

In certain computing environments, multiple host systems may configure groups of data often referred to as “data sets” in storage volumes configured in a storage system, such as interconnected storage devices, e.g., a Direct Access Storage Device (DASD), Redundant Array of Independent Disks (RAID), Just a Bunch of Disks (JBOD), etc. Data sets which may contain a file or many files, are typically comprised of data extents, which typically may comprise data stored in groupings of tracks. The Z/OS® operating system from International Business Machines Corporation (“IBM”) has a Volume Table of Contents (VTOC) to provide to a host, information on data sets of extents configured in the volume, where the VTOC indicates to the host, the location of tracks, extents, and data sets for a volume in storage.

To avoid loss of data, data stored on a volume (often referred to as a primary volume) may be backed up by copying it to another volume (often referred to a secondary volume) frequently stored at another geographical location. Accordingly, in the event that data on the primary volume is lost due to data corruption, hardware or software failure, or a disaster which destroys or damages the primary volume, the backup data may be retrieved from the secondary volume.

Volumes are frequently stored in various storage performance tiers in which a higher performance tier performs input/output (I/O) read and write operations faster than the next lower performance tier. On the other hand, the lower performance tiers typically store larger volumes of data at a lower cost. The high level performance tier storage may be provided by solid state nonvolatile memory, for example, a middle level performance tier storage may be provided by disk drives and a low level storage may be provided by tape drives, for example.

Due to the relatively high cost of higher performance tier storage, it is frequently more economical to move data which is relatively inactive in terms of input/output operations, to lower performance tier storage, and retain the more active data in the higher performance tier storage. To identify storage areas containing data which are candidates for being moved to a lower, less expensive performance tier, heat maps are frequently employed by a storage controller which controls access to the storage in response to input/output requests from the hosts. Each time data within a particular storage area (which may be on the order of a gigabyte in size, for example) is accessed in a read or write operation, the heat map is updated to indicate that that particular storage area is active. Should a particular storage area remain inactive, that is, no read or write accesses have been directed to the gigabyte of data stored within that storage area since a certain date, such as a week, for example, the storage area is deemed inactive and its data may be migrated by the storage controller to a lower performance storage tier.

As previously mentioned, a storage area tracked by a heat map may be relatively large in size, such as a gigabyte, for example. A volume of data is typically even larger, such as three gigabytes, for example. The VTOC for each volume frequently has a “last referenced field” which usually indicates when data within that volume was last accessed.

For example, if data stored in a single volume is read, a “last referenced date” field of the VTOC for that volume, may be updated by the host operating system to indicate when that volume was last accessed. However, a data set may have data stored in multiple volumes. In such cases, the “last referenced” field of the first volume of the data set is used to indicate when any portion of the multivolume data set was last accessed. Accordingly, if any portion of a data set stored in multiple volumes is accessed in a read or write operation, a “last referenced date” field of the VTOC for just the first volume of the multivolume data set, is typically updated by the host operating system to indicate the date the multivolume data set was last accessed.

### SUMMARY

Provided are a computer program product, system, and method for data activity tracking in accordance with the present description, in which metadata is read from a storage unit data structure such as a VTOC, for example, for a storage unit such as a storage volume, for example, storing data of a plurality of data sets in a plurality of data units such as storage allocation units, for example, of the storage unit. In one embodiment, each data unit resides in a storage performance tier of a plurality of storage performance tiers of the storage system. Based upon read metadata, a data set of the storage unit may be classified as one of active and inactive, and if classified as inactive, data units containing data of the inactive classified data set may be selected from the plurality of data units of the storage unit storing data of the plurality of data sets. The data of the inactive classified data set may be migrated from the selected data units of a first storage performance tier to a second storage performance tier having a lower level of storage performance than the first storage performance tier. Other aspects of data activity tracking and migration in accordance with the present description are described.

### BRIEF DESCRIPTION OF THE DRAWINGS

FIG. 1A illustrates an embodiment of a storage environment, employing aspects of data activity tracking in accordance with the present description.

FIG. 1B illustrates another embodiment of a storage environment, employing aspects of data activity tracking in accordance with the present description.

FIG. 2 illustrates an embodiment of a volume table.

FIG. 3 illustrates an embodiment of a data set record.

FIG. 4 illustrates an embodiment of operations of a storage control unit employing data activity tracking in accordance with the present description.

FIG. 5 illustrates another embodiment of operations of a storage control unit employing data activity tracking in accordance with the present description.

FIG. 6 illustrates an embodiment of a sorted list of data set candidates for performance tier migration in accordance with the present description.

FIG. 7 illustrates a computing environment in which the components of FIGS. 1A, 1B may be implemented.

### DETAILED DESCRIPTION

Described embodiments provide techniques for facilitating performance tier data migration operations by data activity tracking in a storage unit such as a storage volume which can be storing data of many different data sets. As explained in greater detail below, data activity tracking in accordance with the present description facilitates selecting suitable candidates for migration to lower storage performance tiers notwithstanding that the data of many different data sets may be intermixed within a particular storage unit.

Prior to data activity tracking in accordance with the present description, heat maps were frequently employed by storage controllers to track data activity within a storage area that may be, for example, a gigabyte in size or larger and may contain the data of many different data sets. Each time data within a particular storage area is accessed in a read or write operation, regardless of which data set the accessed data belongs, the heat map is updated to indicate that that particular storage area is active. Should a particular storage area remain inactive, that is, no read or write accesses have been directed to any of the data stored within that storage area since a certain date, such as a week, for example, the storage area is deemed inactive and its data may be migrated by the storage controller to a lower performance storage tier.

Conversely if data belonging to just a single data set stored within the storage area is accessed at a relatively high level of access, the heat map for the entire storage area is typically marked to indicate that the particular storage area is not a suitable candidate for migration to a lower storage performance tier. Thus, it is appreciated herein that if only one of the data sets in that storage area is actually experiencing a relatively high level of access, the other remaining data sets stored in that same storage area can continue to take up valuable higher performance storage space notwithstanding that they may not have been referenced for days. Moreover, in a main frame environment, many files can be written to one large data set or storage volume. As a result, a large number of inactive files may end up being stored inappropriately in a relatively expensive higher performance storage tier.

In one aspect of the present description, the level of granularity of data activity tracking may be increased to a finer level as compared to prior heat map tracking techniques. For example, in a storage unit such as a storage volume which may contain data of many different data sets, a storage unit data structure is provided for storing metadata for each data set having data stored within the storage volume. In one embodiment, the metadata may be formatted to identify or otherwise indicate for each dataset stored within the storage volume, whether the current status of the data set is active or inactive including status information identifying whether the data set is either open for input/output operations or closed for input/output operations. In addition, the active/inactive status metadata can identify for each dataset stored within the storage volume, the date the data of the data set was last referenced.

As a consequence, each data set having data stored within the particular storage volume may be separately classified as either active or inactive, depending upon or as a function of the metadata for that data set. For example, a data set having data stored within the storage volume may be classified as inactive if both the current status of that data set is identified as closed for input/output operations, and if so, whether the last referenced date of the closed data set is prior to a predetermined interval. The other data sets having data stored within the storage volume may be similarly classified as active or inactive as appropriate. In this manner, a large number of data sets may be separately classified as more suitable or less suitable candidates for performance tier data migration notwithstanding that the data sets all have data stored in a common storage area such as a storage volume.

The metadata may be stored in a storage unit data structure such as, for example, a Volume Table of Contents (VTOC) which is typically stored in the storage volume itself Previously, the VTOC metadata was formatted in a manner suitable for the host to read the VTOC and obtain the metadata stored in the VTOC. In one aspect of the present invention, a storage unit data structure such as a Volume Table of Contents (VTOC) stored in the storage volume may be formatted to be read by the storage controller as well as the host. As a result, in one embodiment, the migration candidate classification of groups of data such as data sets stored in a particular storage units such as a storage volume, as described herein, may be undertaken by the storage controller. It is appreciated that in other embodiments, the migration candidate classification of groups of data such as data sets as described herein may be undertaken by the host, or a combination of both the storage controller and the host, for example, depending upon the particular application. Accordingly, one or both of the host and the storage controller may have logic configured to read the VTOC of a storage volume and obtain appropriate metadata for migration candidate classification.

Once suitable candidates for performance tier data migration have been identified, the data of each suitable candidate may be located and migrated to the appropriate storage performance tier. In many storage controllers, the data of a data set is stored in data extents, each of which may be located in different available storage spaces. As a consequence, the data of a single data set may be dispersed over several different storage units such as storage volumes. In accordance with the present description, each storage volume of a multivolume data set has metadata identifying the active/inactive status of the data set. Previously, metadata such as a “last referenced” field for a data set was stored in the VTOC of just the first volume of a multivolume data set.

Moreover, the location of each extent of a data set stored in a storage volume was identified in metadata of the VTOC which was previously formatted in a manner to be understandable only to logic of the host. In accordance with another aspect of the present description, in one embodiment, the storage controller may also include logic configured to obtain and process the extent location metadata from the VTOC for each data set found to be a suitable candidate for performance tier migration. As a result, the storage controller may be configured to read and understand both the extent location metadata and the active/inactive status metadata information for each data set having data stored in the storage volume. Using this information, the storage controller may have logic configured to separately identify those data extents that belong to an inactive data set, from those data extents belonging to the active data sets, notwithstanding that the data extents of the active and inactive data sets may be intermixed and stored in the same storage volume. In this manner, the storage controller can migrate the data extents of the inactive data sets having data stored in a storage volume to a lower storage performance tier, while maintaining as unchanged, the level or levels of the storage performance tiers of the data extents of the active data sets having data stored in the same storage volume. As a result, data activity tracking in accordance with the present description can, in one embodiment, provide a level of granularity which is more fine than that of prior heat maps and can facilitate a more efficient storage of data in appropriate storage performance tiers. It is appreciated that in other embodiments, other features and advantages may be realized, in addition to, or instead of those described herein, depending upon the particular application.

In one embodiment, a storage unit such as a storage volume, may store data in subunits of storage which are referred to herein as data units or storage subunits. Examples of data units or storage subunits include storage allocation units, cylinders, tracks, gigabytes, megabytes, etc. the relative sizes of which may vary. For example, a storage allocation unit is typically on the order of 16 megabytes in size or 21 cylinders in size, depending upon the appropriate unit of measure.

As previously mentioned, a data set may comprise many data extents, each data extent being stored in a particular storage unit such as a storage volume. A data extent of a data set typically comprises data stored in a plurality of data units or storage subunits such as tracks which are typically physically located in physically contiguous storage areas of the storage unit. Thus, in the context of storage volumes, each data extent of a data set typically comprises data stored in a plurality of physically contiguous tracks of a particular storage volume. It is appreciated that the size of each storage subunit or data unit may vary, depending upon the particular application. A storage controller typically migrates data in groups of data in integral multiples of storage allocation units such that the smallest increment of data being migrated is typically no smaller than a single storage allocation unit.

In some embodiments, the storage unit such as a storage volume, may be a virtual storage volume having a plurality of virtual data units or storage subunits of a storage unit. One example of a virtual data unit is a virtual storage allocation unit. Each virtual storage allocation unit is mapped by the storage controller to an actual physical storage allocation unit in a particular storage performance tier. The mapping of each virtual allocation unit of each data extent stored in a virtual storage volume, is typically contained within the metadata for that data set in the VTOC data structure of the particular virtual storage volume.

Upon migrating data of a data set classified as inactive, from selected physical storage allocation units of one storage performance tier to different physical storage allocation units of a different storage performance tier having a lower level of storage performance, a mapping of each affected virtual allocation units to physical allocation units may be updated to map virtual allocation units of the inactive classified data set which were migrated to different physical storage allocation units in a lower storage performance tier. It is appreciated that data may be migrated in various sizes of data units such as tracks, cylinders, megabytes, gigabytes, data extents, etc.

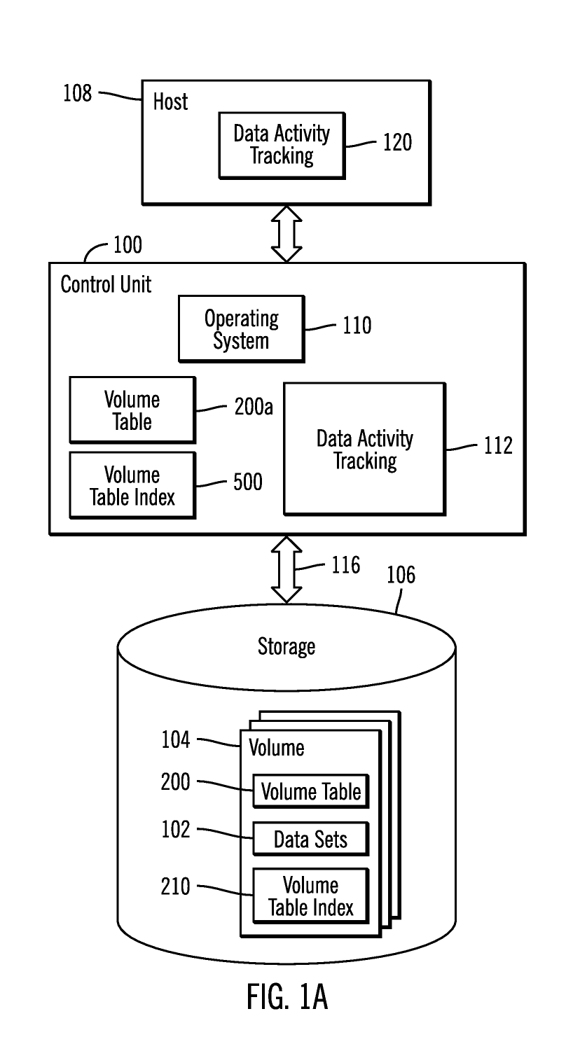

FIG. 1A illustrates an embodiment of a computing environment including a storage control unit 100, such as a storage controller or server, that manages access to data sets 102 configured in storage volumes 104 in a storage 106 by one or more hosts as represented by a host 108 (FIG. 1A). The storage control unit 100 may be a primary storage control unit 100a (FIG. 1B) for a primary storage 106a similar to the storage 106 (FIG. 1A), or may be a secondary storage control unit 100b for a secondary storage 106b similar to the storage 106 (FIG. 1A). The storage volumes 104 (FIG. 1A) of the storages 106a, 106b (FIG. 1A) may be in a peer-to-peer mirror relationship such that data written to one storage volume, typically a primary storage volume in the primary storage 106a, is mirrored to a corresponding secondary storage volume in the secondary storage 106b such that the secondary storage volume is a copy of the primary storage volume. The source of the data written to the storage volumes is typically one or more of the hosts 108. Thus, the hosts 108 issue input/output requests to a storage control unit 100 requesting the storage control unit 100 to read data from or write data to the storage volumes 104 of the storage 106 controlled by the storage control unit 100. It is appreciated that data activity tracking in accordance with the present description is applicable to other types of storage units in addition to storage volumes in a mirrored, peer-to-peer relationship.

A data set 102 (FIG. 1A) comprises a collection of data intended to be stored in a logical allocation of data, such as data from a single application, user, enterprise, etc. A data set 102 may be comprised of separate files or records, or comprise a single file or record. Each record or file in the data set 102 may be comprised of data extents of data.

The storage control unit 100 includes an operating system 110 and data activity tracking control logic 112 to manage the storage of data sets 102 in the storage volumes 104 in accordance with the present description. The operating system 110 may comprise the IBM z/OS® operating system or other operating systems for managing data sets in storage volumes or other logical data structures. (IBM and z/OS are trademarks of IBM worldwide). The data activity tracking control logic 112 may be separate from the operating system 110 or may be included within the operating system. The data activity tracking control logic may be implemented with hardware, software, firmware or any combination thereof.

It is appreciated that some or all of data activity tracking control functions in accordance with the present description may be implemented in one or more of the hosts 108 as represented by the data activity tracking control logic 120 of the host 108. Here too, the data activity tracking control logic 120 may be separate from the operating system of the host or may be included within the host operating system. The data activity tracking control logic 120 may be implemented with hardware, software, firmware or any combination thereof.

Each storage volume 104 includes metadata concerning the data sets 102 stored in one or more storage unit data structures of each storage volume 104 such as a storage volume table 200 having information on the storage volume 104 to which it pertains, including active/inactive status metadata, and extent location metadata for each data set 102 having data stored in the particular storage volume 104. The active/inactive status metadata may be used to classify the status of each data set as active or inactive. The extent location metadata may be used identify the data extents of each data set 102, and to locate the physical storage locations of each data extent of the data sets 102 having data stored in the particular storage volume 104.

The storage volume table 200 may be stored in the storage volume 104, such as in the first few records of the storage volume, i.e., starting at the first track in the storage volume 104. In IBM z/OS operating system implementations, the storage volume table 200 may comprise a storage volume table of contents (VTOC). In other embodiments, the storage volume metadata may include a Virtual Storage Access Method (VSAM) Volume Data Set (VVDS). In one embodiment, the storage volume tables 200 may comprise contiguous space data sets having contiguous tracks or physical addresses in the storage 106. In alternative embodiments, the storage volume table 200 may comprise a file allocation table stored separately from the storage volume 104 or within the storage volume 104. It is appreciated that storage volume metadata may include metadata in other formats describing various aspects of the data sets 102 of the storage volume.

The storage control unit 100 may maintain copies of the storage volume tables 200 to use to manage the data sets 102 in the storage volumes 104. In z/OS implementations, the storage volume table 200, e.g., VTOC, may include extent location metadata describing locations of data sets in the storage volume 104, such as a mapping of tracks in the data sets to physical storage locations in the storage volume. In some embodiments, the storage volume metadata may include active/inactive status metadata fields containing data such as last referenced data identifying the last time a particular data set was accessed. In some embodiments, the storage volume table 200 may comprise other types of file allocation data structures that provide a mapping of data to storage locations, either logical, virtual and/or physical storage locations. In this way, the storage volume table 200 provides a mapping of tracks to data sets 102 in the storage volume 104. In further embodiments, the storage volume table 200 may include metadata such as a storage volume name and data set records indicating data sets having data extents configured in the storage volume 104. Each data set record may have information for each data set 102 in a storage volume 104, including the data units (e.g., tracks, blocks, etc.) assigned to the data set 102. Tracks may be stored in data extents, which provide a mapping or grouping of tracks in the storage volume 104. The storage volume 104 may further include a storage volume table index 210 that maps data set names to data set records in the storage volume table 200. In one embodiment, the metadata may include a mapping of the data extents of each data set 102 (or data set portion) stored within the storage volume 104, to physical allocation units which may be identified by cylinder and/or track numbers, for example.

The storage 106 may comprise one or more storage devices known in the art, such as a solid state storage device (SSD) comprised of solid state electronics, EEPROM (Electrically Erasable Programmable Read-Only Memory), flash memory, flash disk, Random Access Memory (RAM) drive, storage-class memory (SCM), Phase Change Memory (PCM), resistive random access memory (RRAM), spin transfer torque memory (STM-RAM), conductive bridging RAM (CBRAM), magnetic hard disk drive, optical disk, tape, etc. The storage devices may further be configured into an array of devices, such as Just a Bunch of Disks (JBOD), Direct Access Storage Device (DASD), Redundant Array of Independent Disks (RAID) array, virtualization device, etc. Further, the storage devices may comprise heterogeneous storage devices from different vendors or from the same vendor.

The storage control unit 100 communicates with the storage 106 via connection 116. The components of the embodiment depicted in FIG. 1B are similarly interconnected by connections 116a, 116b . . . 116n. The connections 116, 116a, 116b . . . 116n each may comprise one or more networks, such as a Local Area Network (LAN), Storage Area Network (SAN), Wide Area Network (WAN), peer-to-peer network, wireless network, etc. Alternatively, the connections 116, 116a, 116b . . . 116n may comprise bus interfaces, such as a Peripheral Component Interconnect (PCI) bus or serial interface.

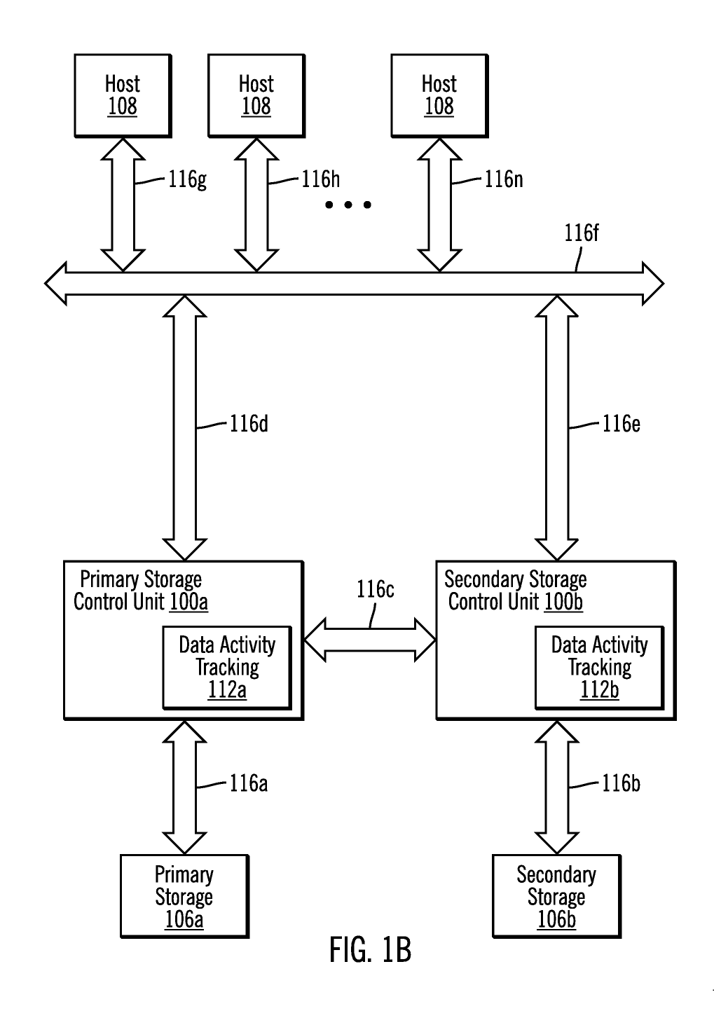

FIG. 2 illustrates an example of an arrangement of information maintained in a storage unit data structure such as an instance of a storage volume table 200ᵢ for one storage volume 104ᵢ. It is appreciated that metadata for a storage unit in accordance with the present description may have other arrangements, depending upon the particular application.

The storage volume table instance 200ᵢ of this example includes a storage volume name 202, also known as a storage volume serial number, e.g., a VOLSER, that provides a unique identifier of the storage volume. The storage volume name 202 may be included in the name of the storage volume table 200ᵢ in the storage volume 104ᵢ. The storage volume table 200ᵢ instance further includes one or more data set records 300₁ . . . 300ₙ indicating data sets having data extents of tracks configured in the storage volume 104ᵢ represented by the storage volume table 200ᵢ. The storage volume table 200ᵢ further includes one or more free space records 204 identifying ranges of available tracks in the storage volume 200ᵢ in which additional data set records 300ₙ₊₁ can be configured. In embodiments where the operating system 110 comprises operating systems such as the Z/OS operating system, the data set records may comprise data set control blocks.

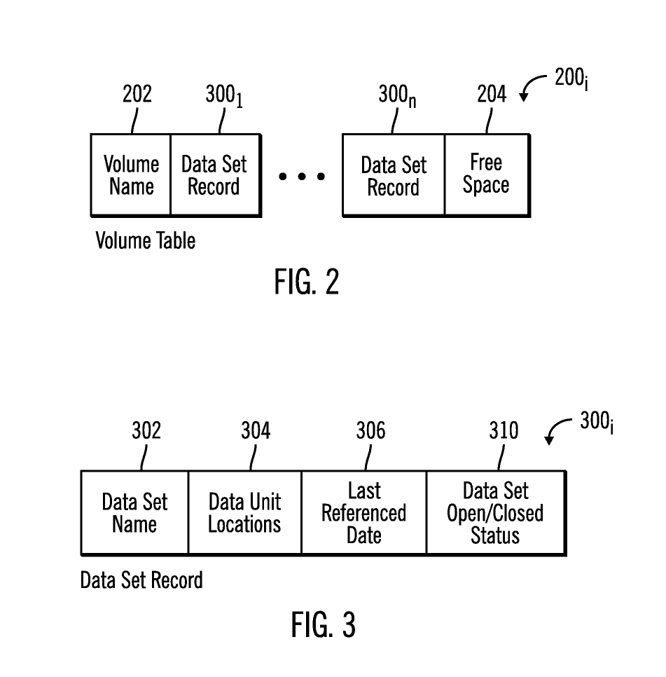

FIG. 3 illustrates an example of an instance of a data set record 300ᵢ, such as one of the data set records 300₁ . . . 300ₙ included in the storage volume table 200ᵢ. Each data set record 300ᵢ contains metadata 302, 304, 306, 310 pertaining to a particular data set 102 (FIG. 1A). In one embodiment, the metadata may be arranged in fields including for example, a field 302 identifying a name for the particular data set, one or more fields 304 identifying the locations of data units such as tracks, extents or storage allocation units, for example, which have been allocated to the data set of the record 300ᵢ, one or more fields 306 identifying the date and time the data set of the record 300ᵢ was last referenced or accessed, and one or more fields 310 indicating whether the data set of the record 300ᵢ is currently open for access by input/output operations, or is currently closed for input/output operations.

It is appreciated that the metadata describing various aspects of the data set of the record 300ᵢ may include other fields, either in addition to or instead of those depicted in this example, depending upon the particular application. The data unit location information 304 may be expressed as disk, cylinder, head and record location (CCHHR), or other formats, either virtual or physical. Terms such as tracks, data units, blocks, storage allocation units, etc., may be used interchangeably to refer to a unit of data managed in the storage volume 104. The storage volume table 200 may be located at track 0 and cylinder 0 of the storage volume 104. Alternatively, the storage volume table 200 may be located at a different track and cylinder number than the first one.

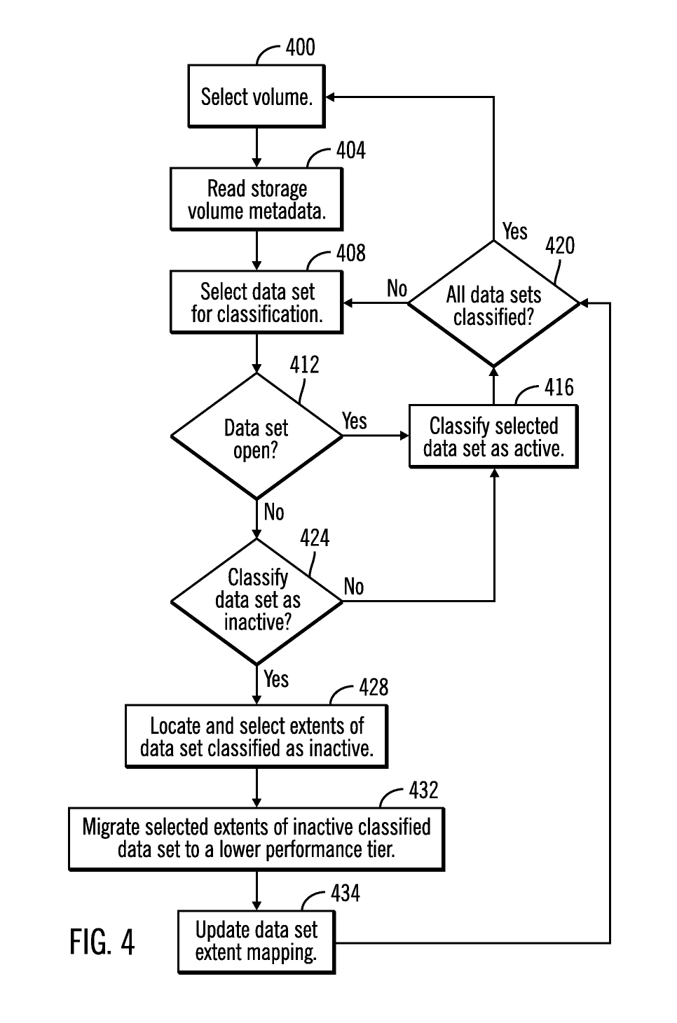

FIG. 4 illustrates an embodiment of operations performed by a data activity tracking logic such as a data activity tracking control logic 112, 112a, 112b, 120 (FIGS. 1A, 1B) in accordance with the present description, in which individual data sets of a storage unit such as a storage volume may be separately classified as active or inactive, and separately migrated to a lower storage performance tier if classified as inactive. In one operation, a storage unit such as a storage volume may be selected (block 400) for processing by the data activity control logic. Metadata describing the data stored in the selected storage volume may be read (block 404) by the data activity tracking control logic.

As previously mentioned, in the illustrated embodiment, each storage volume 104 includes metadata concerning the data sets 102, in which the metadata is stored in one or more storage unit data structures of each storage volume 104, such as a storage volume table 200. The storage unit data structure has information on the storage volume 104 to which it pertains, including active/inactive status metadata, and extent location metadata for each data set 102 having data stored in the particular storage volume 104. The active/inactive status metadata may be used by the data activity tracking control logic to classify the status of each data set as active or inactive. The extent location metadata may be used by the data activity tracking control logic to identify the data extents of each data set 102 stored within the storage volume 104, and to locate the physical storage locations of each data extent of the data sets 102 having data stored in the particular storage volume 104.

Accordingly, based upon the read metadata for the selected storage volume, a data set may be selected (block 408) by the data activity tracking control logic for classification to determine if the selected data set should be classified as active or inactive, that is, whether or not the selected data set is a suitable candidate for performance tier migration. In the illustrated embodiment, as a part of the classification process, a determination is made as to whether the selected data set is open (block 412) for input/output operations. In one embodiment, such a determination may be made by the data activity tracking control logic examining one or more metadata fields 310 (FIG. 3) of a data set record of a Volume Table (FIG. 2) of the selected storage volume, in which the metadata fields 310 indicate whether the data set of the record 300ᵢ is currently open for access by input/output operations, or is currently closed for input/output operations.

If the data activity tracking control logic determines that the selected data set is open (block 412) for input/output operations, the selected data set may be classified (block 416) as active in this embodiment and as such, is likely not a suitable candidate for performance tier data migration in this embodiment. It is appreciated that the criteria for classifying groups of data as suitable candidates for performance tier data migration may vary, depending upon the particular application.

Upon classifying (block 416) the selected data set as active, a further determination may be made by the data activity tracking control logic as to whether all data sets of the particular storage unit have been classified (block 420). If so, another storage unit such as a storage volume may be selected (block 400) for processing by the data activity control logic. If not, another data set of the selected storage unit may be selected (block 408) by the data activity tracking control logic for classification to determine if the selected data set should be classified as active or inactive.

If the data activity tracking control logic determines that the selected data set is closed (block 412) for input/output operations, another determination may be made based upon the read metadata for the selected storage volume, as to whether the selected data should is to be classified (block 424) as inactive, that is, whether the selected closed data set is a suitable candidate for performance tier migration. In one embodiment, such a determination may be made by the data activity tracking control logic examining one or more metadata fields 306 (FIG. 3) of a data set record of a Volume Table (FIG. 2) of the selected data set of the selected storage volume, in which the metadata fields 306 identify the date and time the data set of the record 300ᵢ was last referenced or accessed.

In some storage controller embodiments, the last referenced date field of the metadata is not updated until the data set to which the last referenced date field pertains, is closed. Accordingly, in the embodiment of FIG. 4, the last referenced date field of the metadata for the selected data set is examined (block 424) after the data set has been determined (block 412) to be closed for input/output operations. It is appreciated that in those embodiments in which a last referenced field is updated before the data set has closed, operation of block 412 prior to the operation of block 424 may be omitted. Other operations may be added or omitted, depending upon the particular application.

Once the last referenced date for the selected data set has been obtained, the data activity tracking control logic can compare the last referenced date to various criteria for determining whether the closed selected data set is to be classified (block 424) as inactive, and thus a suitable candidate for performance tier migration. It is appreciated that the levels of relative activity or inactivity status of a data set may vary, depending upon the particular application. In one embodiment, a criterion of a one week interval may be selected as a suitable criterion for determining whether a data set is to be classified as inactive. Thus, if the selected data set is determined to have not been accessed at any time in the prior week, such a data set may be classified as inactive in this example.

It is appreciated that a longer or shorter interval of time may be selected as a suitable criterion for determining whether a data set is to be classified as inactive. In one embodiment, the duration of such an interval of time criterion may be user selectable for example. Thus, if the selected data set is determined to have not been accessed at any time in the immediately prior 24 hours or the immediately prior month, depending upon the selected interval of time, such a data set may be classified as inactive in this example.

It is further appreciated that other criteria may be selected for determining whether the level of input/output operation activity directed to a particular data set is sufficiently low to be classified as inactive. For example, a threshold value for the number of input/output operations over a given interval may be selected as a suitable criterion for determining whether a data set is to be classified as inactive. Thus, in this example, if a data set has been accessed fewer than the selected threshold value over a selected interval of time, the data set may be classified as inactive notwithstanding how recent the last access may have occurred. Other storage performance data migration classification criteria may be selected, depending upon the particular application. It is appreciated that the type of metadata stored in a data structure to represent the level of access activity for each data set may modified to support the particular storage performance data migration classification criteria which have been selected. Thus, in an example in which a data set which has been accessed fewer than a selected threshold value over a selected interval of time, may be classified as inactive, the metadata for each data set may be updated, for example, to indicate the number of input/output operation accesses over the relevant interval of time. Other metadata may be stored, depending upon the particular application.

If the selected data set is to be classified (block 424) as inactive, the data units which are located within the selected storage unit and containing data of the selected data set classified as inactive may be identified, selected (block 428) and located for migration (block 432) to a lower performance tier. In one embodiment, such a determination may be made by the data activity tracking control logic based upon one or more metadata fields 304 (FIG. 3) of the data set record of the selected data set. For example, a storage unit data structure such as a Volume Table (FIG. 2) of the selected storage volume, has metadata fields 304 which indicate the locations of data units located within the selected storage volume, and storing data of the selected data set. In one embodiment, the data unit location metadata stored within the storage unit data structure of the selected data set may be used to identify and select for migration to a lower performance tier, the data units of the data extents of the selected data set.

The data units of the data extents of the selected data set may be expressed within the storage unit data structure of the selected data set, as storage allocation units or storage tracks, for example. The physical locations of the data units of the data extents of the selected data set are, in this example, locations allocated to the selected storage volume, and may be identified and selected (block 428) from the data unit location metadata stored within the storage unit data structure of the selected data set.

As previously mentioned, in some embodiments, the storage unit storing some or all of the selected data set, may be a virtual storage volume having a plurality of virtual storage allocation units. Each virtual storage allocation unit is mapped by the storage controller to an actual physical storage allocation unit in a particular storage performance tier. The mapping of each virtual allocation unit of each data extent stored in a storage volume, is in one embodiment, contained within the metadata for that data set in the VTOC data structure of the particular storage volume.

Upon migrating (block 432) data extents of a data set classified as inactive, from selected physical storage allocation units of one storage performance tier to a different storage performance tier having a lower level of storage performance, a mapping of each affected virtual allocation units to physical allocation units may be updated (block 434) to remap virtual allocation units of the data extents of the inactive classified data set to the new physical storage allocation units' locations in a lower storage performance tier to which they were migrated. It is appreciated that data may be migrated in various sizes of data units such as allocation units, tracks, cylinders, megabytes, gigabytes, etc, and updating the mapping of the migrated data extents to the new locations of the physical data units as appropriate.

Upon updating the data set extent mapping (block 434) of the migrated data set, a further determination may be made by the data activity tracking control logic as to whether all data sets of the particular storage unit have been classified (block 420). If so, another storage unit such as another storage volume may be selected (block 400) for processing by the data activity control logic. If not, another data set of the selected storage unit, may be selected (block 408) by the data activity tracking control logic for classification to determine if the selected data set should be classified as active or inactive.

As previously mentioned, the data of a single inactive data set may be dispersed over several different storage units such as storage volumes. Thus, as each storage unit is selected (block 400), if an inactive multivolume data set has data stored within the selected storage volume, the multivolume data set will be classified as inactive as discussed above, and the data extents of the inactive multivolume data set which are located within the selected storage volume will be migrated to a lower performance storage tier. In accordance with the present description, each storage volume of a multivolume data set has metadata which may be used to determine the active/inactive status of the multivolume data set. Once each volume of a multivolume data set has been selected and processed by data activity tracking logic in accordance with the present description in a manner similar to that described above, the data extents of the inactive data set in each volume of the inactive multivolume data set will have been located and migrated to a lower performance storage tier if the multivolume data set is classified as inactive. Conversely, the data extents of other data sets in each volume which are classified as active, can bypass migration, that is, remain in the higher performance storage tiers notwithstanding the intermingling of data extents of active and inactive data sets within each storage volume.

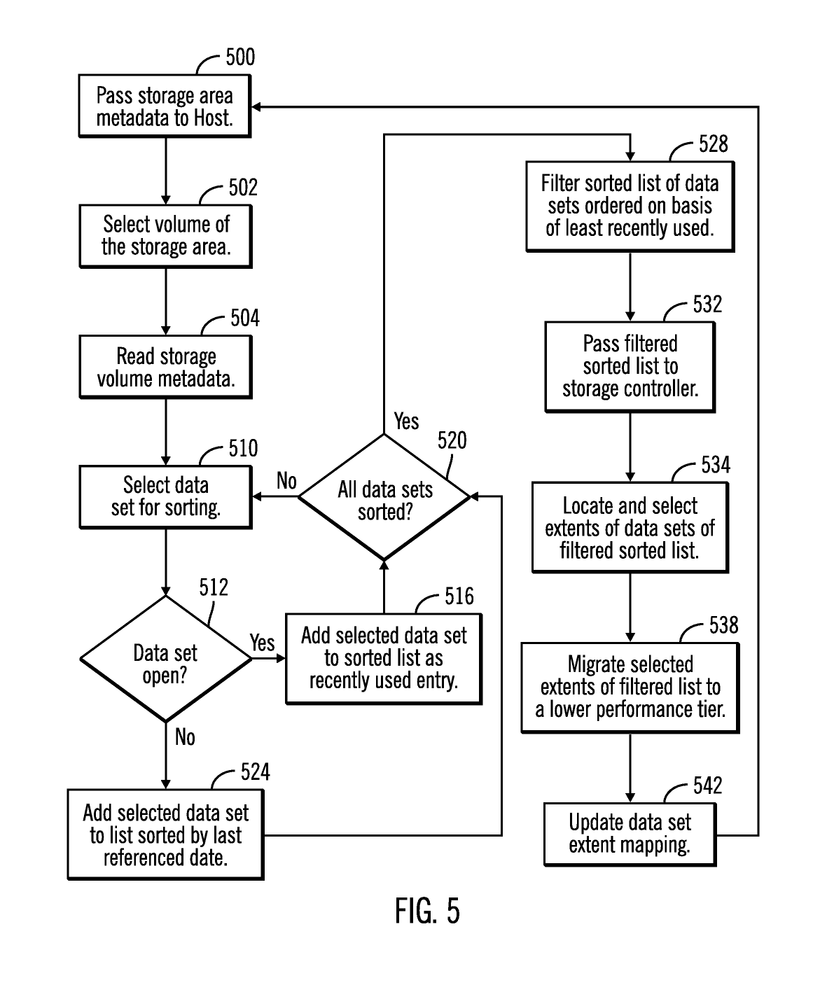

It is appreciated that some or all of data activity tracking control functions in accordance with the present description as depicted in FIG. 4 may be implemented in a storage control unit as represented by the data activity tracking control logic 112, 112a, 112b of one or more of the storage control units 100, 100a, 100b, or in one or more of the hosts 108 as represented by the data activity tracking control logic 120 of the host 108 (FIG. 1A), or a combination thereof FIG. 5 depicts an embodiment of operations in which some data activity tracking operations are performed by a storage control unit data activity control logic such as one or more of the data activity tracking control logic 112, 112a, 112b, and other data activity tracking operations are performed by a data activity control logic of a host such as one or more of the data activity tracking control logic 120 of a host 108. It is appreciated that some or all of the operations depicted as being performed by a storage control unit data activity tracking logic may alternatively be performed by a host data activity tracking logic. Conversely, it is appreciated that some or all of the operations depicted as being performed by a host data activity tracking logic may alternatively be performed by a storage control unit data activity tracking logic, depending upon the particular application.

In one embodiment, metadata describing a range of storage locations for a particular storage area may be read by the data activity tracking control logic of the storage control unit, for example, and passed (block 500) to another data activity control logic such as the data activity control logic 120 of a host 108, for example, for further processing in accordance with the present description. In one example, the range of storage locations of a particular storage area may be defined by a CCHH range and volume (or volumes) identification. It is appreciated that the storage locations defining a particular storage area may be expressed in a variety of different types of data units, depending upon the particular application.

Upon receipt of the metadata describing the range of storage locations and the storage volume (or volumes) of the particular storage area, a storage unit such as a storage volume identified as being within the storage area may be selected (block 502) for processing by data activity control logic of the receiving host. In the embodiment of FIG. 5, the particular storage area has data units of a single volume. It is appreciated that in other embodiments, a storage area may include data units of more than one storage volume. In such embodiments, the process described for the selected volume may be repeated until each volume of the particular storage area has been processed.

For the selected storage volume of the storage area, the data activity tracking control logic of the receiving host 108, may read (block 504) the metadata stored in a storage volume data structure for the selected storage volume. In one embodiment, the data activity tracking control logic of the host operating system of the receiving host 108, accesses information in one or more of Catalog and VTOC data structures, as appropriate, of the selected storage volume, to determine for each data set of the selected storage volume, the last referenced date and the location of all extents of each data set having data stored within the selected storage volume, and whether each data set of the selected storage volume is in use (that is, open for input/output operations). In the illustrated embodiment, the data activity tracking control logic of the receiving host 108, may process the received metadata to prepare a sorted list of data sets, in which the data set entries of the list are sorted and entered on the basis of the least recently used data sets to the most recently used data sets, in this example.

Accordingly, a data set described in the received metadata may be selected (block 510) for sorting on a least to most recently used basis. In this connection, a determination is made as to whether the selected data set is indicated by the received metadata to be open (block 512) for input/output operations.

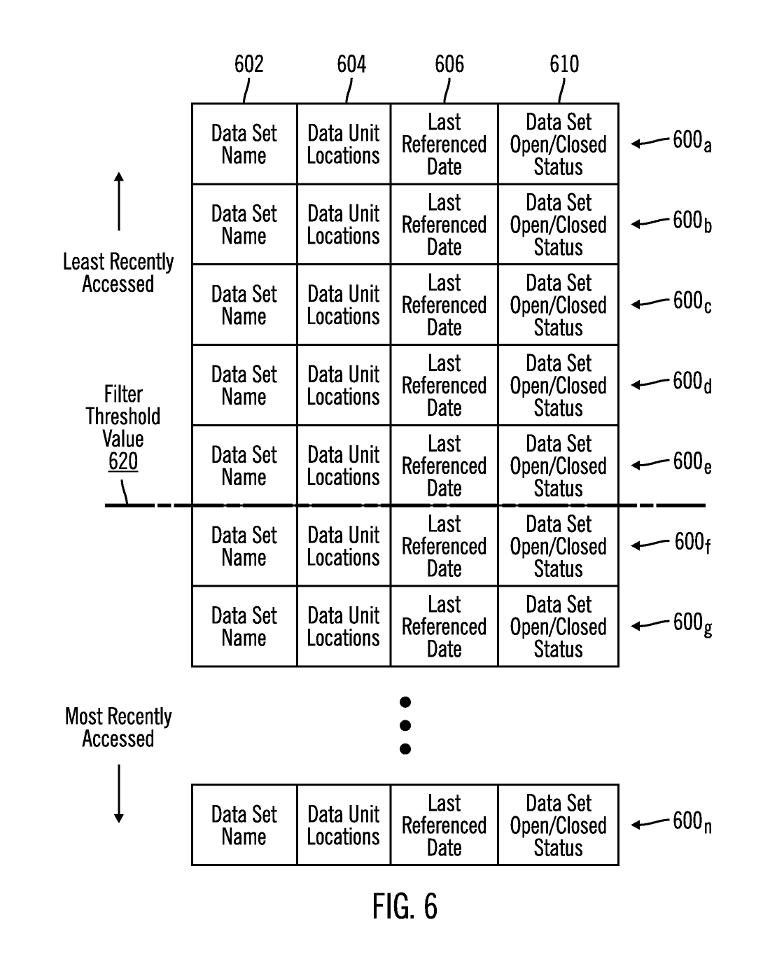

If the data activity tracking control logic of the receiving host determines that the selected data set is open (block 512) for input/output operations, the selected data set may be added (block 516) to the sorted list of data sets as a recently used entry. FIG. 6 shows an example of one embodiment of a sorted list of data set entries 600a, 600b, . . . 600n. In this example, each data set entry 600a, 600b, . . . 600n has fields 602, 604, 606, 610 which may be similar to the fields 302, 304, 306, 310, respectively of a data set record 300ᵢ of

FIG. 3 for the volume table of FIG. 2. Thus, in one embodiment, each data set entry 600a, 600b, . . . 600n may include for example, a field 602 identifying a name for the particular data set, one or more fields 604 identifying the locations of data units such as tracks, extents, or storage allocation units, for example, which have been allocated to the data set of the record 600ᵢ, one or more fields 606 identifying the date and time the data set of the entry 600a, 600b, . . . 600n was last referenced or accessed, and one or more fields 610 indicating whether the data set of the entry is currently open for access by input/output operations, or is currently closed for input/output operations.

Upon adding an entry for the open data set to the sorted list, a further determination may be made by the data activity tracking control logic of the host as to whether all data sets of the particular storage unit such as a storage volume have been sorted (block 520). If not, another data set of the selected storage unit may be selected (block 510) by the data activity tracking control logic of the host for sorting.

If the data activity tracking control logic of the receiving host determines based upon the received metadata, that the selected data set is closed (block 512) for input/output operations, the selected closed data set may be added (block 524) to the sorted list of data sets. The entry for the closed data set is positioned within the sorted list on the basis of the last referenced date for the data set as indicated by the received metadata. Thus, in this embodiment, data sets which are the least recently accessed may be positioned at one end of the list and the data sets which are the most recently accessed may be positioned at the other end of the list, with each data set being positioned within the sorted list on the basis of how recent was the last access to the particular data set.

Upon adding the closed data set to the sorted list, a further determination may be made by the data activity tracking control logic of the host as to whether all data sets of the particular storage unit have been sorted (block 520). If not, another data set of the selected storage unit may be selected (block 510) by the data activity tracking control logic of the host for sorting.

Once it is determined that all data sets of the selected storage unit have been sorted (block 520), the sorted data list may be filtered (block 528) on the basis of which data sets are the least recently used. For example, a threshold value as represented by a filter threshold value 620 (FIG. 6) may be used to filter out the entries of the more recently used data sets from the sorted list. Thus, data set entries such as data set entries 600f, 600g . . . 600n, in this example, which were accessed more recently than a particular threshold value 620 may be classified as relatively active and thereby filtered from the list, leaving the data set entries such as data set entries 600a-600e in this example, having a last referenced date which is earlier than the threshold value. The filtered data set entries 600a-600e remaining on the sorted list after filtering, may thus be classified as relatively inactive and may represent data sets and their data extents which are suitable candidates for performance tier migration to a lower performance storage tier. The threshold filter value 620 may be a default value or may be a user selectable value for example. The threshold filter value may be provided by the host or may be obtained from the storage control unit, for example.

In one embodiment, each data set entry 600a-600e remaining on the filtered list may indicate the location of all data extents or other data units of the inactive data set, which are located within the selected volume. In other embodiments, each data set entry remaining on the filtered list may indicate the location of some or all of the data extents of multivolume data sets which may be located in more than one storage volume.

In this embodiment, the filtered list identifying the locations of extents or other data units of data sets which are suitable candidates for performance tier migration, may be passed by the host data activity tracking control logic to the data activity tracking control logic of the storage controller. Each extent or other data unit of a data set identified on the filtered list as a suitable candidate for performance tier migration, may be located and selected (block 534) by the data activity tracking control logic of the storage controller and migrated (block 538) to a lower performance storage tier in a manner similar to that described above in connection with FIG. 4. Similarly, the data set extent mapping may be updated (block 542) as described above.

In the embodiment of FIG. 4, data sets of a particular storage area or storage unit were classified as active or inactive on a data set by data set basis. In the embodiment of FIG. 5, data sets of a particular storage area or storage unit were first sorted on a data set by data set basis in a list on a basis of least to most recently accessed, and then classified as active or inactive depending upon location on the list. It is appreciated that data sets may be classified as active or inactive or as not suitable or suitable candidates for performance tier migration, using a variety of procedures, depending upon the particular application.

Upon completion of the performance tier migration of the filtered sort list of data extents of data sets, another set of metadata describing a range of storage locations for another storage area may be read by the data activity tracking control logic of the storage control unit, for example, and passed (block 500) to another data activity control logic such as the data activity control logic 120 of a host 108, for example, for further data activity tracking processing as described above in accordance with the present description. In one embodiment, if the range of storage locations for a particular storage area passed to another data activity control logic, includes data units of more than one storage unit or volume, the data sets of each such storage unit or volume of the storage area may be processed as described above before metadata for another storage area is passed (block 500) to the other data activity control logic such as the data activity control logic 120 of a host 108, for example, for data activity tracking processing as described above in accordance with the present description.

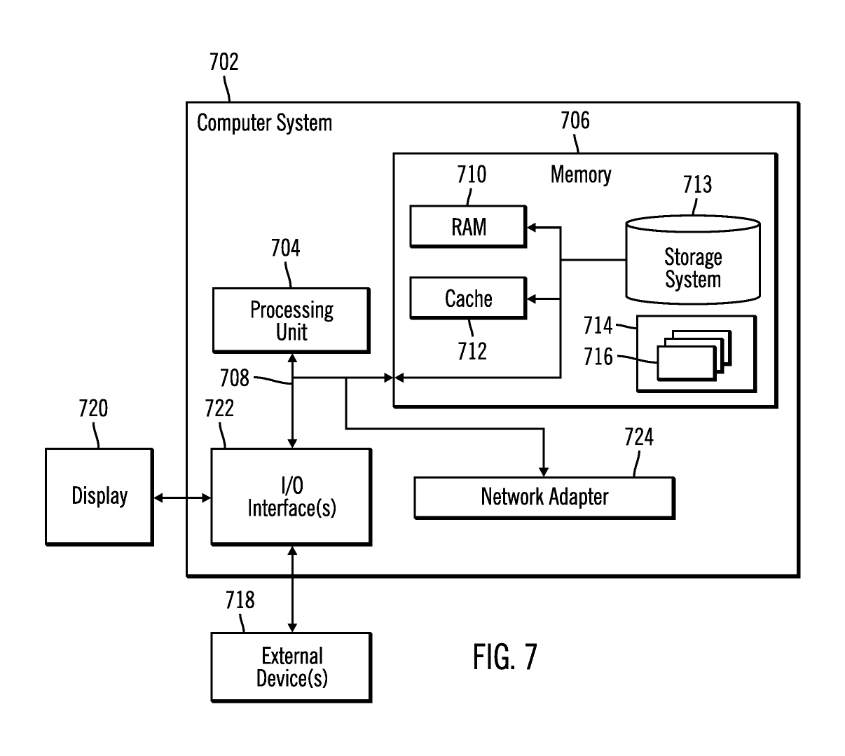

The computational components of FIGS. 1A, 1B, including the controller or storage control unit 100, 100a, 100b, host 108, may each be implemented in one or more computer systems, such as the computer system 702 shown in FIG. 7. Computer system/server 702 may be described in the general context of computer system executable instructions, such as program modules, being executed by a computer system. Generally, program modules may include routines, programs, objects, components, logic, data structures, and so on that perform particular tasks or implement particular abstract data types. Computer system/server 702 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, the computer system/server 702 is shown in the form of a general-purpose computing device. The components of computer system/server 702 may include, but are not limited to, one or more processors or processing units 704, a system memory 706, and a bus 708 that couples various system components including system memory 706 to processor 704. Bus 708 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 702 typically includes a variety of computer system readable media. Such media may be any available media that is accessible by computer system/server 702, and it includes both volatile and non-volatile media, removable and non-removable media.

System memory 706 can include computer system readable media in the form of volatile memory, such as random access memory (RAM) 710 and/or cache memory 712. Computer system/server 702 may further include other removable/non-removable, volatile/non-volatile computer system storage media. By way of example only, storage system 713 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 708 by one or more data media interfaces. As will be further depicted and described below, memory 706 may include at least one program product having a set (e.g., at least one) of program modules that are configured to carry out the functions of embodiments of the invention.

Program/utility 714, having a set (at least one) of program modules 716, may be stored in memory 706 by way of example, and not limitation, as well as an operating system, one or more application programs, other program modules, and program data. Each of the operating system, one or more application programs, other program modules, and program data or some combination thereof, may include an implementation of a networking environment. The components of the computer 702 may be implemented as program modules 716 which generally carry out the functions and/or methodologies of embodiments of the invention as described herein. The systems of FIGS. 1A, 1B may be implemented in one or more computer systems 702, where if they are implemented in multiple computer systems 702, then the computer systems may communicate over a network.

Computer system/server 702 may also communicate with one or more external devices 718 such as a keyboard, a pointing device, a display 720, etc.; one or more devices that enable a user to interact with computer system/server 702; and/or any devices (e.g., network card, modem, etc.) that enable computer system/server 702 to communicate with one or more other computing devices. Such communication can occur via Input/Output (I/O) interfaces 722. Still yet, computer system/server 702 can communicate with one or more networks such as a local area network (LAN), a general wide area network (WAN), and/or a public network (e.g., the Internet) via network adapter 724. As depicted, network adapter 724 communicates with the other components of computer system/server 702 via bus 708. It should be understood that although not shown, other hardware and/or software components could be used in conjunction with computer system/server 702. Examples, include, but are not limited to: microcode, device drivers, redundant processing units, external disk drive arrays, RAID systems, tape drives, and data archival storage systems, etc.

It is appreciated that data activity tracking in accordance with one embodiment of the present description, facilitates performance tier data migration operations by data activity tracking in a storage unit such as a storage volume which can be storing data of many different data sets. As set forth above, data activity tracking in accordance with the present description facilitates selecting suitable candidates for migration to lower storage performance tiers notwithstanding that the data of many different data sets may be intermixed within a particular storage unit.

The reference characters used herein, such as i, j, and n, are used to denote a variable number of instances of an element, which may represent the same or different values, and may represent the same or different value when used with different or the same elements in different described instances.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method, comprising operations of a processor in a computing system having a storage system, the processor operations comprising:
reading metadata from a storage unit data structure for a storage unit storing data of a plurality of data sets in a plurality of data units of the storage unit, each data unit residing in a storage performance tier of a plurality of storage performance tiers of the storage system;
based upon read metadata, classifying a first data set of the storage unit as one of active and inactive;
if classified as inactive, selecting data units containing data of the inactive classified first data set from the plurality of data units of the storage unit storing data of the plurality of data sets; and
migrating data of the inactive classified first data set from the selected data units of a first storage performance tier to a second storage performance tier having a lower level of storage performance than the first storage performance tier.

2. The method of claim 1 further comprising:
based upon read metadata, classifying a second data set of the storage unit as one of active and inactive; and
if classified as active, maintaining the storage performance tier unchanged for data units of the storage unit storing data of the active classified second data set.

3. The method of claim 1 further comprising maintaining in a storage unit data structure for the storage unit, metadata identifying for each data set having data stored within the storage unit, whether the current status of the data set is one of open for input/output operations and closed for input/output operations, and metadata identifying the date the data of the data set was last referenced, and wherein the classifying a first data set of the storage unit as one of active and inactive is a function of whether the current status of the first data set having data stored in the storage unit is identified as closed for input/output operations, and if so, whether the last referenced date of the closed first data set is prior to a predetermined value.

4. The method of claim 1 further comprising a host issuing input/output requests to a storage controller controlling the storage unit, and wherein the metadata reading operations are performed by the host and wherein the data migrating operations are performed by the storage controller in response to data from the host identifying data set candidates for migration and locations of data units storing data of each data set candidate for migration.

5. The method of claim 1 further comprising a host issuing input/output requests to a storage controller controlling the storage unit, and wherein the metadata reading operations are performed by the storage controller and wherein the data migrating operations are performed by the storage controller in response to data generated by the storage controller identifying data set candidates for migration and locations of data units storing data of each data set candidate for migration.

6. The method of claim 3 wherein the storage unit is a storage volume of storage and the data unit is a storage allocation unit of the storage volume, and the data structure is a volume table of contents (VTOC) for the storage volume, wherein the metadata maintaining includes maintaining in the volume table of contents (VTOC) for the storage volume, metadata identifying for each dataset stored within the storage volume, whether the current status of the data set is one of open for input/output operations and closed for input/output operations, and metadata identifying the date the data of the data set was last referenced; and
wherein a multivolume data set has data stored in a collection of storage volumes, each storage volume of the collection of storage volumes having a volume table of contents (VTOC) storing metadata identifying for the multivolume dataset stored within the storage volume, whether the current status of the multivolume data set is one of open for input/output operations and closed for input/output operations, and metadata identifying the date data of the multivolume data set was last referenced.

7. The method of claim 1 wherein the storage unit is a storage volume of storage and the data unit is a storage allocation unit of the storage volume, and the data structure is a volume table of contents (VTOC) for the storage volume, and the data set comprises data stored in a plurality of data extents, each data extent comprising data of the data set stored in a plurality of physically contiguous storage allocation units.

8. The method of claim 7 wherein the storage volume is a virtual storage volume having a plurality of virtual storage allocation units, each virtual storage allocation unit being mapped to a physical storage allocation unit in a storage performance tier, said method further comprising, upon migrating data of the inactive classified first data set from selected physical storage allocation units of the first storage performance tier to the second storage performance tier having a lower level of storage performance than the first storage performance tier, updating a mapping of virtual allocation units to physical allocation units to map virtual allocation units of the inactive classified first data set migrated to physical storage allocation units of the second performance tier.

9. A computer program product for a computing system having a host issuing input/output requests to a storage system having a storage controller and a plurality of storage units coupled to the storage controller, the computer program product comprising at least one computer readable storage medium having computer readable program instructions embodied therewith, the program instructions executable by at least one processor of the computing system to cause the at least one processor to perform operations, the operations comprising:
reading metadata from a storage unit data structure for a storage unit storing data of a plurality of data sets in a plurality of data units of the storage unit, each data unit residing in a storage performance tier of a plurality of storage performance tiers of the storage system;
based upon read metadata, classifying a first data set of the storage unit as one of active and inactive;
if classified as inactive, selecting data units containing data of the inactive classified first data set from the plurality of data units of the storage unit storing data of the plurality of data sets; and
migrating data of the inactive classified first data set from the selected data units of a first storage performance tier to a second storage performance tier having a lower level of storage performance than the first storage performance tier.

10. The computer program product of claim 9 wherein the operations further comprise:
based upon read metadata, classifying a second data set of the storage unit as one of active and inactive; and
if classified as active, maintaining the storage performance tier unchanged for data units of the storage unit storing data of the active classified second data set.

11. The computer program product of claim 9 wherein the operations further comprise maintaining in a storage unit data structure for the storage unit, metadata identifying for each data set having data stored within the storage unit, whether the current status of the data set is one of open for input/output operations and closed for input/output operations, and metadata identifying the date the data of the data set was last referenced, and wherein the classifying a first data set of the storage unit as one of active and inactive is a function of whether the current status of the first data set having data stored in the storage unit is identified as closed for input/output operations, and if so, whether the last referenced date of the closed first data set is prior to a predetermined value.

12. The computer program product of claim 9 wherein the metadata reading operations are performed by a processor of the host and wherein the data migrating operations are performed by a processor of the storage controller in response to data from the host identifying data set candidates for migration and locations of data units storing data of each data set candidate for migration.

13. The computer program product of claim 9 wherein the metadata reading operations are performed by a processor of the storage controller and wherein the data migrating operations are performed by a processor of the storage controller in response to data generated by the storage controller identifying data set candidates for migration and locations of data units storing data of each data set candidate for migration.

14. The computer program product of claim 11 wherein the storage unit is a storage volume of storage and the data unit is a storage allocation unit of the storage volume, and the data structure is a volume table of contents (VTOC) for the storage volume, wherein the metadata maintaining includes maintaining in the volume table of contents (VTOC) for the storage volume, metadata identifying for each dataset stored within the storage volume, whether the current status of the data set is one of open for input/output operations and closed for input/output operations, and metadata identifying the date the data of the data set was last referenced; and
wherein a multivolume data set has data stored in a collection of storage volumes, each storage volume of the collection of storage volumes having a volume table of contents (VTOC) storing metadata identifying for the multivolume dataset stored within the storage volume, whether the current status of the multivolume data set is one of open for input/output operations and closed for input/output operations, and metadata identifying the date data of the multivolume data set was last referenced.

15. The computer program product of claim 9 wherein the storage unit is a storage volume of storage and the data unit is a storage allocation unit of the storage volume, and the data structure is a volume table of contents (VTOC) for the storage volume, and the data set comprises data stored in a plurality of data extents, each data extent comprising data of the data set stored in a plurality of physically contiguous storage allocation units.

16. The computer program product of claim 15 wherein the storage volume is a virtual storage volume having a plurality of virtual storage allocation units, each virtual storage allocation unit being mapped to a physical storage allocation unit in a storage performance tier, said operations further comprising, upon migrating data of the inactive classified first data set from selected physical storage allocation units of the first storage performance tier to the second storage performance tier having a lower level of storage performance than the first storage performance tier, updating a mapping of virtual allocation units to physical allocation units to map virtual allocation units of the inactive classified first data set migrated to physical storage allocation units of the second performance tier.

17. A computing system comprising:
a storage system comprising a storage controller having a processor, and a plurality of storage units arranged in a plurality of storage performance tiers coupled to the storage controller, said storage controller adapted to control the plurality of storage units, each storage unit having a storage unit data structure and adapted to store data of a plurality of data sets in a plurality of data units of the storage unit, each data unit residing in a storage performance tier of the plurality of storage performance tiers of the storage system;
a host having a processor and adapted to issue input/output requests to the storage controller; and
a computer program product comprising at least one computer readable storage medium having computer readable program instructions embodied therewith, the program instructions executable by at least one processor of the computing system to cause the at least one processor to perform operations, the operations comprising:
reading metadata from a storage unit data structure for a storage unit storing data of a plurality of data sets in a plurality of data units of the storage unit;
based upon read metadata, classifying a first data set of the storage unit as one of active and inactive;
if classified as inactive, selecting data units containing data of the inactive classified first data set from the plurality of data units of the storage unit storing data of the plurality of data sets; and
migrating data of the inactive classified first data set from the selected data units of a first storage performance tier to a second storage performance tier having a lower level of storage performance than the first storage performance tier.

18. The system of claim 17 wherein the operations further comprise:
based upon read metadata, classifying a second data set of the storage unit as one of active and inactive; and
if classified as active, maintaining the storage performance tier unchanged for data units of the storage unit storing data of the active classified second data set.

19. The system of claim 17 wherein the operations further comprise maintaining in a storage unit data structure for the storage unit, metadata identifying for each data set having data stored within the storage unit, whether the current status of the data set is one of open for input/output operations and closed for input/output operations, and metadata identifying the date the data of the data set was last referenced, and wherein the classifying a first data set of the storage unit as one of active and inactive is a function of whether the current status of the first data set having data stored in the storage unit is identified as closed for input/output operations, and if so, whether the last referenced date of the closed first data set is prior to a predetermined value.

20. The system of claim 17 wherein the metadata reading operations are performed by a processor of the host and wherein the data migrating operations are performed by a processor of the storage controller in response to data from the host identifying data set candidates for migration and locations of data units storing data of each data set candidate for migration.

21. The system of claim 17 wherein the metadata reading operations are performed by a processor of the storage controller and wherein the data migrating operations are performed by a processor of the storage controller in response to data generated by the storage controller identifying data set candidates for migration and locations of data units storing data of each data set candidate for migration.

22. The system of claim 19 wherein the storage unit is a storage volume of storage and the data unit is a storage allocation unit of the storage volume, and the data structure is a volume table of contents (VTOC) for the storage volume, wherein the metadata maintaining includes maintaining in the volume table of contents (VTOC) for the storage volume, metadata identifying for each dataset stored within the storage volume, whether the current status of the data set is one of open for input/output operations and closed for input/output operations, and metadata identifying the date the data of the data set was last referenced; and
wherein a multivolume data set has data stored in a collection of storage volumes, each storage volume of the collection of storage volumes having a volume table of contents (VTOC) storing metadata identifying for the multivolume dataset stored within the storage volume, whether the current status of the multivolume data set is one of open for input/output operations and closed for input/output operations, and metadata identifying the date data of the multivolume data set was last referenced.

23. The system of claim 17 wherein the storage unit is a storage volume of storage and the data unit is a storage allocation unit of the storage volume, and the data structure is a volume table of contents (VTOC) for the storage volume, and the data set comprises data stored in a plurality of data extents, each data extent comprising data of the data set stored in a plurality of physically contiguous storage allocation units.

24. The system of claim 23 wherein the storage volume is a virtual storage volume having a plurality of virtual storage allocation units, each virtual storage allocation unit being mapped to a physical storage allocation unit in a storage performance tier, said operations further comprising, upon migrating data of the inactive classified first data set from selected physical storage allocation units of the first storage performance tier to the second storage performance tier having a lower level of storage performance than the first storage performance tier, updating a mapping of virtual allocation units to physical allocation units to map virtual allocation units of the inactive classified first data set migrated to physical storage allocation units of the second performance tier.
